(19) United States
(12) Patent Application Publication
(10) Pub. No.: US 2016/0312103 A1
(43) Pub. Date: Oct. 27, 2016

(54) Salt Solutions for Hydrate Plug Inhibition and Removal

(71) Applicant: Nachurs Alpine Solutions, Corp., Marion, OH (US)

(72) Inventors: Sanjay Wahal, Delaware, OH (US); Franklin Kroh, Marion, OH (US); Christopher Houston, Sugar Land, TX (US)

(21) Appl. No.: 15/139,112

(22) Filed: Apr. 26, 2016

Related U.S. Application Data
(60) Provisional application No. 62/153,262, filed on Apr. 27, 2015.

(51) Int. Cl. C09K 8/528

(52) U.S. Cl. CPC C09K 8/528

(57) ABSTRACT

The present development is for chemical composition and method for use in the oil and gas industry to reduce the risk of formation of hydrate plugs and to facilitate the removal of hydrate plugs if they do form. Specifically, the present development comprises an aqueous salt solution at a concentration high enough to create a sufficient freezing point depression in a natural gas mixture to effectively inhibit the formation of a hydrate plug. Optionally, the composition may further comprise a low molecular weight alcohol and/or a glycol and/or a low concentration corrosion inhibitor.

### CROSS-REFERENCE TO PRIOR APPLICATIONS

The present application claims priority to U.S. Patent Application 62/153,262 filed 2015 Apr. 27, currently pending, which is incorporated by reference in its entirety.

### FIELD OF THE INVENTION

The invention relates to a composition and method that can be used in the oil and gas industry to reduce the risk of formation of hydrate plugs during the extraction and transport of natural gas or a mixture of natural gas and crude oil, or that will facilitate the removal of hydrate plugs if they do form. The method may be used to prevent, reduce, or remediate plugging of conduits, pipes, transfer lines, valves, and other equipment where conditions allow for hydrate formation.

### BACKGROUND OF THE INVENTION

In the oil and gas exploration and production industry, it is well-known that hydrates can form in crude oil and natural gas streams during extraction. As used herein, the term “hydrate” refers to a solid phase compound formed from a combination of water and small molecules found in crude oil and natural gas streams that are usually gaseous at room temperature. Hydrates are formed under low temperature and high pressure conditions when an optimal amount of water and methane, ethane, n-butane, isobutene, carbon dioxide, or a combination thereof are present. Hydrate formation is also favored in the presence of turbulence (high fluid velocity and/or agitation) or of a nucleation site.

If the hydrates remain as isolated units, they readily flow with the natural gas and can be removed from the gas stream after extraction. More frequently, however, conditions are favorable for hydrate agglomeration and the subsequent formation of hydrate plugs. When the hydrate plugs form they block or severely restrict the flow of the hydrocarbon stream, which can cause a build-up of pressure upstream of the hydrate plug creating hazardous working conditions for employees. The hydrate plugs are typically porous and permeable, but the characteristics of any particular plug is dependent on the compounds that created it.

It is known in the art that the hydrate plugs may form at any point along a pipeline or at a wellhead, and may occur in downholes, in subsea environments, or above ground. Because hydrate formation and hydrate plug formation normally occurs under low temperature conditions, the hydrate plug may be removed by “melting” the plug—heating it above the formation temperature. However, a large plug may take several days to melt, effectively shutting down operations at the affected location.

Alternatively, additives may be introduced to the gas stream to inhibit the formation of the hydrate plug. At present, the most common additives to remove a hydrate plug and to reduce the risk of hydrate plug formation are ethylene glycol and methanol. When these compounds are added to the gas stream, they reduce the freezing point for the hydrates minimizing the probability of plug formation at normal operating temperatures. More recently, U.S. Pat. No. 8,932,996 teaches use of a nitrate brine to inhibit hydrate formation, wherein the nitrate brine may further be supplemented with a corrosion inhibitor, and wherein the corrosion inhibitor may include a C₁-C20 carboxylic acid salt. Related U.S. Publications 2015/0087561 and 2015/0087562 teach the use of a phosphate brine alone or in combination with the nitrate brine. U.S. Published Application 2014/0066339 describes hydrate agglomeration inhibitors comprising a salt, a weighting agent, a viscosifying agent, and an agglomeration inhibitor. The agglomeration inhibitor is a steepwater soluble from the residue of wet processing of grains, sugar cane, sugar beets, and similar plants, and the salts taught include chlorides, bromides, formates, calcium nitrate, acetates, and combinations thereof. Chemical remedies developed to date tend to react relatively slowly, be expensive, and/or include components that are not readily available or that may produce other hazards for employees.

### SUMMARY OF THE PRESENT INVENTION

The present development is for a chemical composition and method that can be used in the oil and gas industry to reduce the risk of formation of hydrate plugs in crude oil or natural gas streams, or that will facilitate the removal of hydrate plugs. Specifically, the present development comprises an aqueous salt solution that can create a sufficient freezing point depression in a natural gas mixture to effectively inhibit the formation of a hydrate plug. Optionally, the composition may further comprise a low molecular weight alcohol and/or a glycol and/or a corrosion inhibitor.

### DETAILED DESCRIPTION OF THE PRESENT DEVELOPMENT

The present development is a chemical composition and method to reduce the risk of formation of hydrate plugs in natural gas streams and that will facilitate the removal of hydrate plugs if they do form. Specifically, the present development comprises an aqueous salt solution wherein the salt anion is an acetate, formate, bromide, chloride, nitrate, or combination thereof. Optionally, the aqueous salt solution may further comprise a low molecular weight alcohol and/or a glycol and/or a corrosion inhibitor.

The aqueous salt solution is preferably comprised of a salt wherein the salt anion is an acetate, formate, bromide, chloride, nitrate, or combination thereof. The associated cation may be potassium, sodium, calcium, zinc, cesium, ammonium and other salt cations as are known in the art. Exemplary salts for this purpose include potassium acetate, potassium formate, cesium formate, zinc bromide, calcium bromide, calcium chloride, calcium nitrate, and combinations thereof.

The salt concentration necessary for the composition is based on the composition of the hydrate plug or the chemical components in the environment that may promote plug formation, the environmental temperature and pressure. The salt should be at a sufficiently high concentration that a freezing point depression effectively inhibits the formation of a hydrate plug. The recommended minimum concentration of salt is about 7.0 wt % of the total composition, but the salt concentration may be as high as 68.0 wt % of the total composition. In a preferred embodiment, the salt concentration is from about 15.0 wt % to about 55.0 wt %. In a more preferred embodiment, the salt concentration is from about 22.0 wt % to about 42.0 wt %.

Optionally, the composition may further comprise a corrosion inhibitor at a concentration of up to about 1.0% by weight. A number of corrosion inhibitors are known in the art and any commercial corrosion inhibitor may be used, provided however, that the concentration of the inhibitor must be held low enough to not affect the freezing point depression created by the salt.

By way of example, it has been found that a 50 wt % potassium acetate solution or a 50 wt % potassium formate solution is more efficient at penetrating a THF-NaCl clathrate than a 50 wt % ethylene glycol solution or a 100 wt % methanol solution. To determine the efficiency of the salt solutions, a 5-gram tetrahydrofuran (THF)-NaCl—H₂O clathrate hydrate is prepared and cooled in a 0° C. ice bath for about five minutes, and then treated with a 5-gram test solution that is cooled in a 0° C. ice bath for about five minutes. Table I shows the results when the test solution is 100% methanol, 50% ethylene glycol solution, 50% potassium acetate solution, and 50% potassium formate solution:

TABLE I

| | Time Required for Solution to | |
|---|---|---|
| Test Solution | Penetrate Clathrate | |
| 100% methanol | 30 | minutes |
| 50% ethylene glycol solution | 45-60 | seconds |
| 50% potassium acetate solution | about 12 | seconds |
| 50% potassium formate solution | about 2 | seconds |

Based on this test, the 50% potassium acetate solution and 50% potassium formate solution appear to be more efficient at penetrating a THF-NaCl clathrate than the 50% ethylene glycol solution. Further, the 50% potassium acetate solution and 50% potassium formate solution appear to be significantly more effective at penetrating a THF-NaCl clathrate than the 100% methanol.

In a first exemplary embodiment of a composition of the present invention, not intended to be limiting with respect to scope of the invention, the hydrate plug inhibitor consists essentially of an acetate salt or a formate salt or a chloride salt or a bromide salt or a nitrate salt and a corrosion inhibitor in water. In a first preferred embodiment, a composition made according to the present invention comprises an acetate salt with a concentration of at least 30 wt % and a corrosion inhibitor at a concentration of not more than 1.0 wt %. In a more preferred embodiment, the salt is a potassium acetate salt with a salt concentration from about 32 wt % to about 57 wt %, and the corrosion inhibitor has a concentration of from about 0.10 wt % to about 0.30 wt %.

In a second preferred embodiment, the salt is formate salt at a concentration of at least 20 wt % and the corrosion inhibitor has a concentration of not more than 1.0 wt %. In a more preferred embodiment, the salt is potassium formate at a concentration of from about 20.0 wt % to about 30.0 wt %, and the corrosion inhibitor has a concentration of from about 0.10 wt % to about 0.30 wt %.

In a third preferred embodiment, the salt is a chloride salt or a bromide salt at a concentration of at least 28 wt % and the corrosion inhibitor has a concentration of not more than 1.0 wt %. In a more preferred embodiment, the salt is potassium bromide at a concentration of from about 30 wt % to about 45 wt % and the corrosion inhibitor has a concentration of from about 0.10 wt % to about 0.30 wt %.

Optionally, the composition may further comprise an organic compound with at least one hydroxyl group, such as a low molecular weight alcohol, a glycol, glycerol or a combination thereof. The alcohol may be any C1-C6 alcohol or combination thereof. A preferred alcohol is methanol. The glycol may be any C2-C6 glycol or combination thereof. A preferred glycol is ethylene glycol. The concentration of the alcohol/glycol may be up to about 15 wt % of the total composition. When used in combination with the salt having an anion selected from the group consisting of an acetate, formate, bromide, chloride, nitrate, or combination thereof, the salt concentration may be decreased in the presence of the alcohol or glycol without affecting the performance of the composition.

Without limiting the scope of the invention nor intending to provide an exhaustive list of possible combinations, exemplary compositions anticipated by this development are presented in Table II. Optionally, up to 1.0 wt % of a corrosion inhibitor may be added to any of the formulations below. Water balances the compositions.

TABLE II

| Composition | Salt | wt % salt | Alcohol | wt % alc |
|---|---|---|---|---|
| A | potassium acetate | 65.0 | none | — |
| B | potassium formate | 23.0 | none | — |
| C | sodium formate | 30.0 | none | |
| D | sodium acetate | 50.0 | none | |
| E | sodium nitrate | 41.5 | none | |
| F | sodium bromide | 37.0 | none | |
| G | sodium formate | 13.5 | methanol | 4.5 |
| H | potassium formate | 10.0 | methanol | 5.6 |
| I | potassium acetate | 23.0 | methanol | 12.0 |
| J | sodium acetate | 27.0 | methanol | 8.3 |
| K | potassium acetate | 7.0 | ethylene glycol | 12.0 |
| L | potassium formate | 10.0 | ethylene glycol | 5.0 |
| M | sodium acetate | 12.5 | ethylene glycol | 12.5 |
| N | sodium formate | 23.0 | ethylene glycol | 4.6 |

In a fourth preferred embodiment, a composition comprises an acetate salt with a concentration of at least 10.0 wt %, methanol at a concentration of not more than 10 wt %, and a corrosion inhibitor at a concentration of not more than 1.0 wt %. In a more preferred embodiment, the salt is a potassium acetate salt with a salt concentration from about 10.0 wt % to about 25.0 wt %, methanol with a concentration of from about 2.0 wt % to about 10.0 wt %, and the corrosion inhibitor has a concentration of from about 0.10 wt % to about 0.30 wt %.

In a fifth preferred embodiment, the salt is formate salt at a concentration of at least 10.0 wt %, methanol at a concentration of not more than 15 wt %, and the corrosion inhibitor has a concentration of not more than 1.0 wt %. In a more preferred embodiment, the salt is potassium formate at a concentration of from about 10 wt % to about 20 wt %, methanol with a concentration of from about 2.0 wt % to about 10.0 wt %, and the corrosion inhibitor has a concentration of from about 0.10 wt % to about 0.30 wt %.

The chemical composition of the present invention is intended to be used in the oil and gas industry to reduce the risk of formation of hydrate plugs in crude oil or natural gas streams. It is anticipated that the composition will also facilitate the removal of hydrate plugs that have formed in pipelines during crude oil or natural gas stream recovery. Compared to the currently available compositions, the present composition reacts much faster, is less expensive, and comprises components that are readily available in the marketplace.

Unless defined otherwise, all technical and scientific terms used herein have the same meaning as commonly understood by one of ordinary skill in the art to which the presently disclosed subject matter pertains. Representative methods, devices, and materials are described herein, but are not intended to be limiting unless so noted.

The terms “a”, “an”, and “the” refer to “one or more” when used in the subject specification, including the claims. Thus, for example, reference to “a hydrate” includes a plurality of such hydrate molecules, and so forth.

Unless otherwise indicated, all numbers expressing quantities of components, conditions, and otherwise used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed application.

All compositional percentages used herein are presented on a “by weight” basis, unless designated otherwise.

It is understood that, in light of a reading of the foregoing description and drawings, those with ordinary skill in the art will be able to make changes and modifications to the present invention without departing from the spirit or scope of the invention, as defined herein. For example, those skilled in the art may.

What is claimed is:

1: A composition for a hydrate plug inhibitor consisting essentially of (a) a salt selected from the group consisting of sodium chloride, magnesium chloride, calcium chloride, potassium chloride, sodium formate, potassium formate, cesium formate, ammonium formate, sodium bromide, potassium bromide, calcium bromide, zinc bromide, ammonium chloride, zinc chloride, calcium nitrate, potassium acetate, magnesium acetate, and combinations thereof; (b) a corrosion inhibitor present at a concentration of not more than 1.0 wt %; and (c) water.

2: The composition of claim 1 wherein the salt is selected from the group consisting of sodium formate, potassium formate, cesium formate, ammonium formate, potassium acetate, magnesium acetate, and combinations thereof.

3: The composition of claim 1 wherein the salt is present at a concentration of at least 7.0 wt % of the composition.

4: The composition of claim 1 wherein the salt is present at a concentration of at least 22.0 wt % of the composition.

5: A composition for a hydrate plug inhibitor consisting essentially of (a) a salt selected from the group consisting of sodium chloride, magnesium chloride, calcium chloride, potassium chloride, sodium formate, potassium formate, cesium formate, ammonium formate, sodium bromide, potassium bromide, calcium bromide, zinc bromide, ammonium chloride, zinc chloride, calcium nitrate, potassium acetate, magnesium acetate, and combinations thereof; (b) an organic compound with at least one hydroxyl group; (c) a corrosion inhibitor present at a concentration of not more than 1.0 wt %; and (d) water.

6: The composition of claim 5 wherein the salt is selected from the group consisting of sodium formate, potassium formate, cesium formate, ammonium formate, potassium acetate, magnesium acetate, and combinations thereof.

7: The composition of claim 5 wherein the organic compound with at least one hydroxyl group is selected from the group consisting of a C1-C6 alcohol, a C2-C6 glycol, glycerol and combinations thereof.

8: The composition of claim 7 wherein the C1-C6 alcohol is methanol.

9: The composition of claim 7 wherein the C2-C6 glycol is ethylene glycol.

10: The composition of claim 5 wherein the salt is selected from the group consisting of sodium formate, potassium formate, cesium formate, ammonium formate, potassium acetate, magnesium acetate, and combinations thereof, and the organic compound with at least one hydroxyl group is methanol.

11: The composition of claim 5 wherein the salt is present at a concentration of at least 7.0 wt % of the composition.

12: The composition of claim 5 wherein the salt is present at a concentration of at least 22.0 wt % of the composition.

13: The composition of claim 5 wherein the organic compound with at least one hydroxyl group is present at a concentration of less than 15.0 wt % of the composition.

14: The composition of claim 13 wherein the organic compound with at least one hydroxyl group is present at a concentration of less than 10.0 wt % of the composition.

15: A composition for a hydrate plug inhibitor comprising (a) a salt selected from the group consisting of sodium chloride, magnesium chloride, calcium chloride, potassium chloride, sodium formate, potassium formate, cesium formate, ammonium formate, sodium bromide, potassium bromide, calcium bromide, zinc bromide, ammonium chloride, zinc chloride, calcium nitrate, potassium acetate, magnesium acetate, and combinations thereof; (b) a corrosion inhibitor present at a concentration of not more than 1.0 wt %; and (c) water.

16: The composition of claim 15 wherein the salt is selected from the group consisting of sodium formate, potassium formate, cesium formate, ammonium formate, potassium acetate, magnesium acetate, and combinations thereof.

17: The composition of claim 15 further including an organic compound with at least one hydroxyl group is selected from the group consisting of a C1-C6 alcohol, a C2-C6 glycol, glycerol and combinations thereof.

18: The composition of claim 17 wherein the salt is selected from the group consisting of sodium formate, potassium formate, cesium formate, ammonium formate, potassium acetate, magnesium acetate, and combinations thereof, and the organic compound with at least one hydroxyl group is methanol.
